(19) United States
(12) Patent Application Publication
(10) Pub. No.: US 2010/0000277 A1
(43) Pub. Date: Jan. 7, 2010

(54) GRANULATED PLANT NUTRIENT

(76) Inventors: William W. Keller, Batesville, AR (US); Lyn Kelley, Sulphur Rock, AR (US)

Correspondence Address: BLANK ROME LLP, WATERGATE, 600 NEW HAMPSHIRE AVENUE, N.W., WASHINGTON, DC, 20037, US

(21) Appl. No.: 12/166,788

(22) Filed: Jul. 2, 2008

(51) Int. Cl. C05F 7/00; B01D 1/26

(52) U.S. Cl. 71/12; 159/17.1

(57) ABSTRACT

The present invention relates to apparatus, systems and methods for making municipal sludge based plant nutrient. In particular, the plant nutrient of the present invention is substantially free of noxious odor and retains valuable nutrients, while solving the problem of disposal of municipal sludge and the high cost of energy associated with treating and the transportation and land-filling the ever growing volume of municipal bio-solids.

### FIELD OF THE INVENTION

The present invention relates to municipal sludge based plant nutrient, and apparatuses and methods for making thereof. In particular, the plant nutrient of the present invention is substantially free of noxious odor and retains valuable nutrients, while solving the problem of disposal of municipal sludge and the high cost of energy associated with treating, transporting, and land-filling the ever growing volume of municipal bio-solids.

### BACKGROUND OF THE INVENTION

Municipal sludge has long been a problem associated with urban living. The current methods of waste management for municipal sludge are settling solids in wastewater ponds or using various methods of removing a large percentage of water with the use of polymers or consuming high levels of energy to produce high temperature heat necessary to kill the pathogens and then deposit the resulting product into landfills or dumping it onto farmland. Although the current method removes the sludge from the wastewater treatment site, this method is simply moving the problem to another location.

The major risks and disadvantages of the current method of disposal are the noxious odor, reduction of available landfills, contamination of the ground water and, most importantly, the risk of spreading disease from live pathogens. Most wastewater management organizations report that their sludge qualifies as a Class A material in which 95% of the pathogens have been killed (this may qualify as having been reduced to an acceptable level) but the risks still exist and are detrimental to human and animal life. Prior use of municipal sludge as a plant nutrient material has been restricted by laws and public dissent relating to exposure to disease carrying pathogens and the accompanying malodor.

Therefore, there remains a need for an apparatuses, systems, and methods to make plant nutrient created from municipal bio-solids (sludge) or highly acidic materials or pathogen containing materials that has acceptable odor and retains valuable nutrients, while eliminating the possibility of human and animal contamination from disease causing pathogens.

### SUMMARY OF THE INVENTION

An object of the present invention provides a process for making sludge based plant nutrients by combining bio-solids (sludge) and calcium oxide, e.g. in the form of pebbles, to form a lightweight granule suitable for spreading by air or conventional plant nutrient applicators. This method kills the pathogens in the sludge, while locking in valuable nutrients, to produce granules without the heavy, noxious odor of raw sewage or municipal bio-solids (sludge). This method may also include a liming effect that gives an added value to the soil by increasing the pH in acidic soil thus eliminating the need to lime separately in the fields.

The product of the present invention is ideal for grass and cropland, being free of dust and pungent odor; and its application and use much preferred, when compared to land-filling raw sludge that carries live pathogens and toxins that may spread disease and contaminate valuable water supply. The present invention benefits the agricultural industry, while at the same time, assists municipalities in waste removal and environmental cleanup.

The finished plant nutrient of the present invention contains municipal sludge processed using polymers and calcium oxide at a proper ratio as defined in our process. Typical maximum time from raw material introduction to finished product is approximately 45 minutes. This is the time it takes to achieve the complete process, i.e. from mixing of the raw materials (sludge and calcium oxide) to the final granulated product. The process can be fully automated and sized to accommodate desired daily tonnage requirements. The finished product can be safely stored at the facility without any special treatment.

Another object of the present invention provides apparatus, equipment, and systems for carrying out the process for making sludge based plant nutrients.

### BRIEF DESCRIPTION OF THE DRAWINGS

FIG. 1 is a schematic drawing of a preferred process for making the present plant nutrient.

### DETAILED DESCRIPTION OF THE PREFERRED EMBODIMENT

The plant nutrient of the present invention comprises municipal sludge and calcium oxide (CaO). The relative amounts of the components are preferably about 75-80% (by weight) of municipal sludge (the sludge is usually about 20% solid matter and about 80% water) and about 20-25% (by weight) of calcium oxide.

The calcium oxide is preferably in the form of pebbles and serves to eliminate malodor and reduces the water in sludge material to a dry granulated plant nutrient material. In an embodiment, the calcium oxide should have a minimum quality of 94% CaO, preferably greater than 94%, produce a heat rise (due to lime slaking as discussed below) of about 50 degrees F. or greater in 2 minutes, and have particles sizes from ¼″ to ¾″, with a minimum of dust, preferably ¼″ dust free particles (this may be achieved by using a ¾″ calcium oxide and regrinding the material down to ¼″ to maintain quality and heat rise). Many calcium oxide products on the market do not have this level of quality.

The municipal sludge (bio-solids) and calcium oxide are mixed together to form a mixture. It is preferred that the mixing blends the components together into a smooth and homogeneous appearance. The contaminated municipal water generally has a polymer agent in it that bonds to the particulates and settles them into the material known as “sludge or bio-solids.” The polymer is typically added to the wastewater at the treatment plant and conveniently acts as a binding agent to carry and make small granules. The slaking process (the reaction between calcium oxide and water to form calcium hydroxide, which occurs when the calcium oxide is mixed with the sludge) kills the pathogens and binds the sludge into small granules. To optimize the slaking, binding, and dehydration of the sludge, control of the heat that is generated by mixing the sludge and the calcium oxide is important. This is usually accomplished by using the proper ratio of calcium oxide to sludge, which is generally calculated based on the water content of the sludge as discussed below.

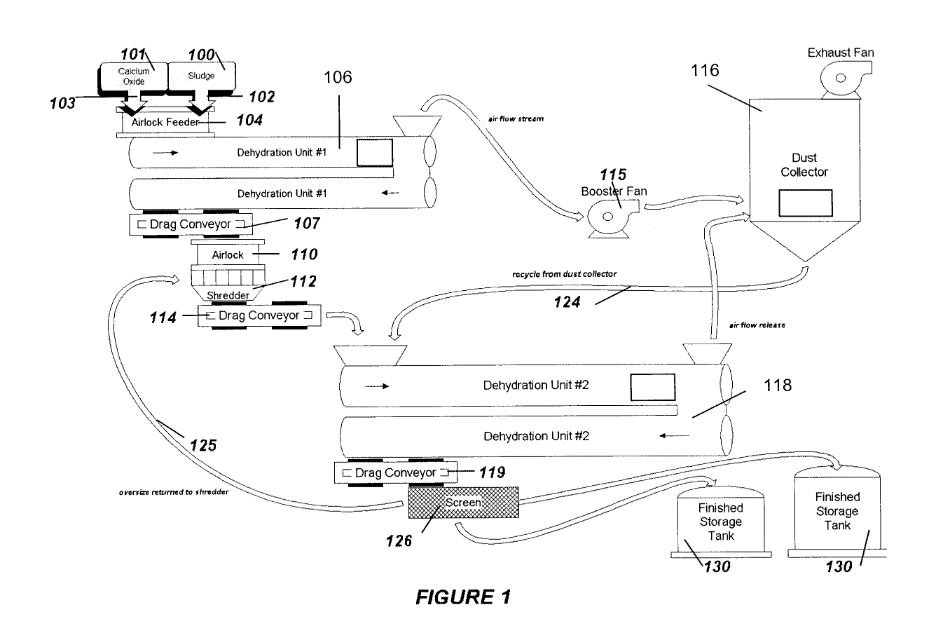

FIG. 1 illustrates a preferred process for making the present plant nutrient. The municipal sludge is metered into the first air lock feeder 104 from a sludge connection 100 that receives the material by way of a conveyor handling system 102. The conveyor 102 preferably contains a weighing system, preferably an electronic system, to properly dispense controlled amounts of sludge into the first air lock feeder 104. The calcium oxide is metered into the first air lock feeder 104 from a lime hopper 101 by way of conveyor 103. The lime hopper 101 preferably contains an electronic weighing system to properly dispense controlled amounts of calcium oxide into the first air lock feeder 104. Air lock feeders are used in the process to contain the materials and to isolate and control the exposure of the process to the external environment. This allows the process emission and environmental release to be controlled and, preferably, contained to produce a minimal amount environmental pollutants. Preferably, the complete process is self-contained and emit no pollutant.

The calcium oxide and municipal sludge is then fed into a first dehydration unit 106, where the amount of calcium oxide added is determined by the water content of the wet sludge. The water content of the sludge is determined prior to the sludge being mixed with the calcium oxide. The simplest way to determine water content of sludge is to measure its weight before and after drying. The difference in weight between the wet sludge and the dry sludge is its water content. For the present invention, in a preferred embodiment, 4 parts of water in the wet municipal sludge by weight is introduced with 1 part calcium oxide. The calcium oxide is preferably stored in a hopper 101 that dispenses calcium oxide, by way of a conveyor 103, directly into the air lock feeder 104 which feeds the first dehydration unit 106. Like the conveyor 102, the calcium oxide hopper conveyor 103 preferably contains an electronic weighing system to dispense proper amounts of calcium oxide into the dehydration unit 106.

The first dehydration unit 106 is preferably a mixer that stirs and mixes the calcium oxide and the wet sludge to facilitate a reaction between the calcium oxide and water of the sludge. Within the first dehydration unit 106, the introduction of the municipal sludge and calcium oxide creates a chemical reaction producing a volatile high heat action. Heat sensors and electronic controls are preferably used to maintain exhaust steam temperature within the first dehydration unit 106 from about 220 to 280 degrees F. This chemical reaction begins the dehydration process while neutralizing and killing the pathogens and bacteria in the material. Through the dehydration process, the thermal heat changes the chemical structure of the calcium oxide to a hydroxide and then eventually back to carbonates. All steam generated from the first dehydration unit 106 is contained within a closed system and is removed with the aid of a booster fan 115 to a dust collector 116. The material is then moved from the first dehydration unit by way of a drag conveyor 107 to a second air lock feeder 110, then to a shredder 112. The shredder 112 de-lumps the material so that any sludge material which had not previously been in contact with the calcium oxide is made to do so, thus, furthering the reaction between the sludge and the calcium oxide. The de-lumping process breaks up clumps of material into granules for processing in a second dehydration unit 118. The post-shredding material is then conveyed by a drag conveyor 114 into the second dehydration unit 118. The second dehydration unit 118 is also a mixer having variable speed control of the blades or paddles contained therein for further breaking down and removal of the excess moisture from the material. The second dehydration unit 118 is also a closed system that is vented to the dust collector 116. No external heat is required in the second dehydration unit 118, which mixes and vents the granules for further drying and granulation. The operation of the second dehydration unit can also be used to control the final granule size. For example, if a smaller granule size is desired, the mixer is run at a higher speed; and if a large granule size is desired, the mixer is run at a slower speed. The granules leaving the second dehydration unit 118 should be at about ambient temperature. In a preferred embodiment, the second dehydration unit 118 produces semi-dry granules (semi-dry contain about 15% to 30% moisture), that are conveyed by way of a third drag conveyor 119 to a separator screen 126 where the granules are separated by size and conveyed to vented storage tanks 130 with air ventilation. As used herein “semi-dry” refers to a moisture content of about 15-30%. Lower than about 15% moisture, the granules loses its useful nitrogen content; and greater than about 30% moisture, the granules loses its integrity and reverts to a liquid mass. Thus, the optimal moisture content in the final product is preferably about 15-30%, most preferably about 30%.

Typically, the screening system 126 separates the granules into two different sizes: 6 to 14 mesh and 14 to 30 mesh. The oversized granules (larger than 6 mesh) are returned to the shredder 112, e.g. via conveyor 125, to be reduced to the desired granule size.

The complete process requires no secondary heating because the heat and reaction during the lime slaking process is sufficient to remove excess water and to kill any pathogens in the sludge. The resulting granules contain valuable nitrogen and other nutrients that are bound therein.

Material collected in the dust collector 116 is re-circulated by a conveyor 124 into the second dehydration unit 118 and bound eventually to the finished product. The finished product is easily handled and applied because it remains loose, free flowing and does not clump.

The equipment is designed for flexibility using feed and speed controls for efficiency. The control center for the system is completely automated and components electronically controlled using heat, weight, speed, and current sensors.

The following Table 1 demonstrates the plant nutrient of the present invention.

Granulated Plant Nutrient

| | |
|---|---|
| Total Nitrogen | 0.5-1.50% |
| Total Phosphorus | 0.5-1.50% |
| Total Potassium | 0.3-2.00% |
| Total Calcium | 29.00-38.00% |
| Fecal Coliform & Pathogens | None Detected |

The invention has been described herein for sludge; however, the present process can also be used for high acid soil, pathogen-containing soil, or poultry litter, as long as the proper calcium oxide to water content is used.

The invention has been disclosed broadly and illustrated in reference to representative embodiments described above. Those skilled in the art will recognize that various modifications can be made to the present invention without departing from the spirit and scope thereof.

What is claimed is:

1. A method for making a plant nutrient comprising the steps of
a. mixing calcium oxide and sludge to form a mixture;
b. dehydrating the mixture;
c. shredding the dehydrated mixture; and
d. further dehydrating the granules produced in step c.

2. The method of claim 1, wherein step b uses the heat produced by the mixing of the calcium oxide and the sludge.

3. The method of claim 1, further comprising the step of screening granules produced in step c to separate the granules by size.

4. The method of claim 1, wherein the calcium oxide used in step a is about one part (by weight) to four part (by weight) of the water content of the sludge.

5. The method of claim 1, where in the calcium oxide is 94% pure.

6. The method of claim 1, wherein step a produces a heat rise of 50 F or greater.

7. The method of claim 1, wherein the particle size of the calcium oxide is 0.25 inches.

8. The method of claim 1, wherein the calcium oxide content in step a is about 29-38% of the total material of step a.

9. The method of claim 1, the total nitrogen content of the granules produced in step d is about 0.5-1.50% by weight of the granule.

10. The method of claim 1, the total phosphorus content of the granules produced in step d is about 0.5-1.50% by weight of the granule.

11. The method of claim 1, wherein the air produced in steps b and d is collected and recycled to the inlet of step d.

12. The method of claim 1, wherein all steps are preformed in a closed system.

13. The method of claim 1, wherein granules produced in step d having a size larger than about 6 mesh are recycled to step c.

14. The method of claim 1, wherein step b takes place at about 220 to 280 degrees F.

15. An apparatus for the production of a plant nutrient comprising
a. an airlock feeder for mixing sludge and calcium oxide;
b. a first dehydration unit for drying the mixture of sludge and calcium oxide;
c. a shredder for granulating the mixture from the first dehydration unit; and
d. a second dehydration unit for drying the granules produced in step c.

16. The apparatus of claim 1, wherein the first dehydration unit uses heat produced by mixing the sludge and the calcium oxide.

17. The apparatus of claim 1, further comprising a screen for separating the granules produced in step d into different sizes.

18. The apparatus of claim 1, wherein the apparatus is a closed system.

19. The apparatus of claim 1, further comprising a dust collector for collection of gas produced in the first and second dehydration units.

20. The apparatus of claim 1, wherein the second dehydration unit requires no external heating.
